(19) United States
(12) Patent Application Publication
(10) Pub. No.: US 2007/0186979 A1
(43) Pub. Date: Aug. 16, 2007

(54) Device for maintaining the water level in pools, ponds and fountains

(76) Inventors: William Thompson, Bakersfield, CA (US); Justin Reynolds, Bakersfield, CA (US)

Correspondence Address: SETO PATENTS, 406 RIVERLAND DR., SALEM, VA, 24153, US

(21) Appl. No.: 11/350,423

(22) Filed: Feb. 10, 2006

(51) Int. Cl. F17D 1/08

(52) U.S. Cl. 137/236.1; 137/386; 137/398

(57) ABSTRACT

A device for automatically maintaining a desired water level in a water structure, such as a pond, pool or decorative water fountain. The device includes a reserve tank that is connected to the water structure by an open tube, or pipe, thus allowing the water level in the reserve tank to be the same as the water level in the water structure. When the water level in the structure drops, so does the water level in the device. When the water level in the device drops below a pre-defined level, a water supply switch is activated and more water is added to the reserve tank. As water is added to the reserve tank, water also flows through the open tube into the water structure, and the water levels in the reserve tank and in the water structure both rise at similar rates. When the water level in the reserve tank reaches a pre-defined full level, the water supply switch is de-activated and the flow of water to the reserve tank, and to the water structure, is shut off.

### BACKGROUND OF THE INVENTION

The present invention relates generally to the field of outdoor water fountains and manmade ponds and more specifically to a device for automatically maintaining a desired water level in fountains and ponds.

Large decorative water fountains are important architectural structures that beautify city squares, indoor malls and public parks. Man-made ponds are other important water structures that add life to pubic parks, private residences and other outdoor venues. Both, decorative water fountains and man-made ponds must have their water levels artificially maintained in order to ensure proper functioning. The traditional method of maintaining water levels in man-made water structures, such as fountains, pools and man-made ponds, is to provide a permanent or temporary water supply pipe to the water structure. A permanent water supply pipe usually terminates at the water structure at a level above the water level in the water structure, so the pipe is above ground and visible to patrons visiting the water structure. Permanent water supply pipes typically have a hand cranked on/off valve that maintenance personnel must manually open when water is to be added to the water structure and manually close when the water structure is filled. The most widely used temporary water supply is a hose, such as a traditional garden hose. Hoses are rolled out to the water structure and the open end (the end from which water flows) is temporarily placed inside the structure. Again, maintenance personnel must manually open an on/off valve in order to start the flow of water to the structure. The maintenance personnel must then monitor the water level in the water structure and manually shut off the water supply from the hose when the structure is full.

What to often happens in the above traditional methods of maintaining water levels in man-made water structures is, while adding water to the structure, the maintenance person get distracted with other duties or simply forgets that the water supply is on and the water structure is over-filled. Over-filling outdoor water structures wastes water and can cause water run off problems. Over-filling indoor water structures can be disastrous. What is needed in the field is a device that automatically monitors the water level in man-made water structures and automatically fills the structures with water as needed. The ideal device would be hidden from view so that it does not detract from the aesthetics of the structure. The ideal device would also automatically start filling the water structure when the water level in the structure falls below a pre-defined “low” level, and automatically stop filling the structure when the water level in the structure reaches a pre-defined “full” level.

The ideal water leveler would also take advantage of hydrostatic pressure, wherein two bodies of water that are connected by a conduit will settle at the same water level. An ideal water leveler would also operate on water pressure only (no electrical power), thereby allowing the leveler to be placed virtually anywhere outdoors.

### SUMMARY OF THE INVENTION

A device that is adapted for connection to a structure that holds water, including ponds, pools and fountains. The device automatically maintains a desired level of water in the structure and, the device can be placed at a location that is remote from the structure, thereby preserving the aesthetic beauty of the pond, pool or fountain. The device comprises a reserve tank, a water supply tube, a water outlet tube, and a pressure sensitive switch. The reserve tank receives water from a water supply and selectively dispenses the water to the water structure. The water supply tube has a first end that extends into an interior of the reserve tank and a second end connected to the water supply. The water outlet tube has a first end connected to a lower portion of the reserve tank and a second end connected to the water structure. The pressure sensitive switch is connected to the first end of the water supply tube, wherein the switch allows water to enter the interior of the reserve tank when the switch is in an open position and the switch prevents water from entering the reserve tank when the switch is in a closed position. A floating part floats on top of the water in the reserve tank and is mechanically connected to the pressure sensitive switch. When the water in the reserve tank is at a pre-defined full level the floating part causes the switch to move to the closed position, and when the water in the reserved tank drops below a pre-defined low level the floating part causes the switch to move to the open position.

The desired level of water in the structure is defined as being at a first height and the pre-defined full level in the reserve tank is designed to be at the same first height. Further, the first and second ends of the water outlet tube are open and unobstructed so that the flow of water from the reserve tank to the structure is only controlled by hydrostatic pressure. The location where the device is placed can be a distance away from the structure sufficient enough to allow the device to be at least partially hidden behind an object, including natural objects and man-made objects. The reserve tank is preferably cylindrical in shape and includes a removable cover.

It is an object of the present invention to automatically maintain a desired water level in water structures such as ponds, pools and large water fountains.

It is a further object of the present invention to provide a device for maintaining the water level, wherein the device does not require electricity.

It is yet another object of the present invention to provide an automated water leveler that is remote from the water structure and can be hidden from view.

### BRIEF DESCRIPTION OF THE DRAWINGS

The invention of the present application will now be described in more detail with reference to the accompanying drawings, given only by way of example, in which:

FIG. 1 shows a perspective view of the preferred embodiment in its operational position;

FIG. 2 shows the exterior of the housing unit of the preferred embodiment;

FIG. 3 is a side cross-sectional view of the housing unit, showing the internal parts and a full water level;

FIG. 4 is a side cross-sectional view of the housing unit, showing a less than full water level; and,

FIG. 5 is a side plan view of the preferred embodiment and an exemplary water structure.

### DETAILED DESCRIPTION OF THE INVENTION

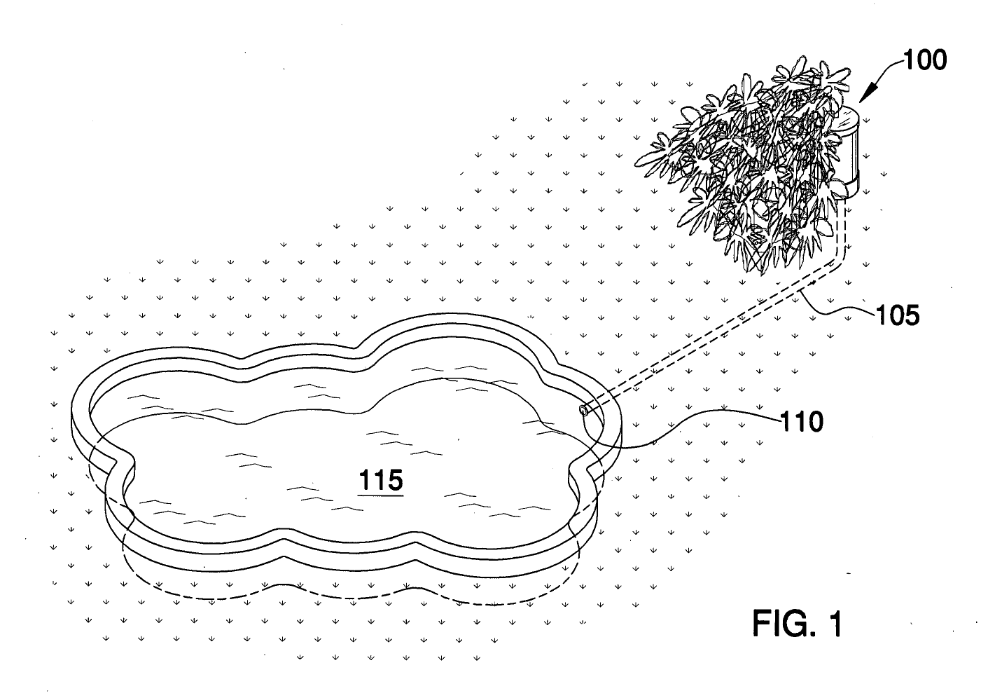

The present invention is designed to automatically maintain a desired level of water in a fountain, pond or other structure that holds water. In FIG. 1, the preferred embodiment of the present water leveler 100 is connected to pond 115 by outlet pipe 105. The present invention takes advantage of hydrostatic pressure so that when the water level of the pond 115 drops, the water level in the water leveler 100 also drops. When the water level drops below a preset level, the water leveler 100 automatically forces more water into the pond 115. Water flows through outlet pipe 105 and enters the pond 115 via opening 110. The present water leveler 100 can advantageously be hidden from view behind a bush or other shrubbery, so as to maintain the aesthetically pleasing appearance of the pond 115 and its surroundings. Further, the outlet pipe 105 is preferably buried underground and the outlet pipe's opening 110 is under water. Thus, all parts of the present invention can be hidden from view.

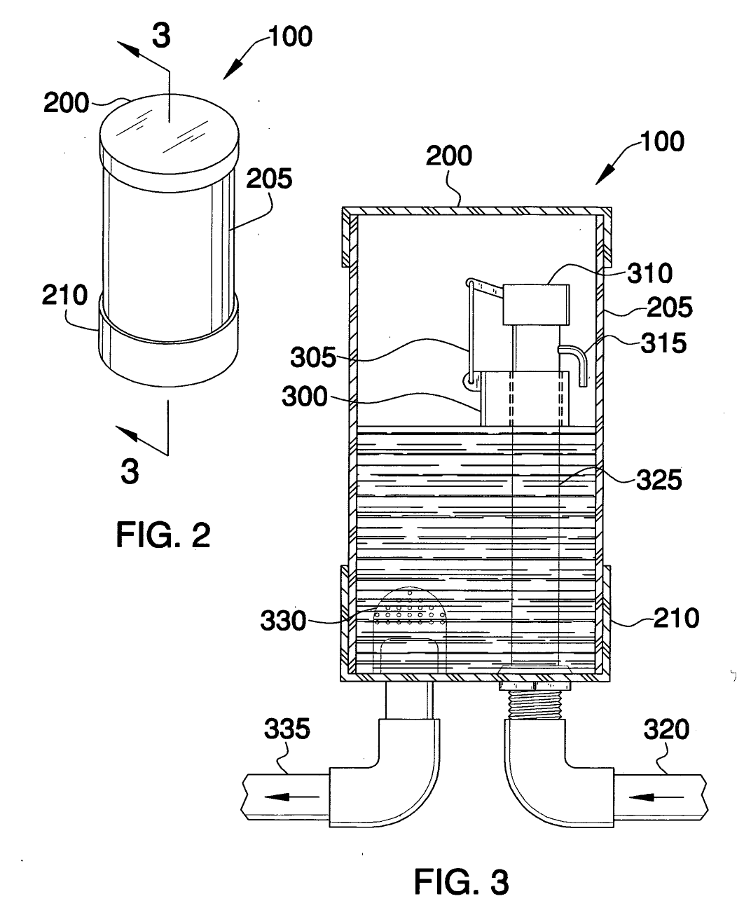

FIG. 2 shows the exterior of the main housing unit, or reserve tank, of the present water leveler 100. The housing unit includes a cylindrical body 205, a lid 200 that is preferably removable, and a base portion 210 that is permanently sealed to the bottom of the cylindrical body 205. The seal between the body 205 and base portion 210 is a waterproof seal. The arrows with the number 3 next to them indicate the perspective provided in the cross-sectional view of FIG. 3.

FIG. 3 is a cross-sectional view of the reserve tank of the present water leveler 100. The internal parts of the present water leveler 100 include a water inlet tube 325, a float 300, an activation arm 305, an activation switch 310, and a fill tube 315. FIG. 3 illustrates a situation wherein the water level within the leveler 100 is at or above the predefined “full” level. Thus no water is being added to the interior of the leveler 100. The float 300 floats on top of the water within the leveler and since the water is sufficiently high, the float 300 has pushed the activation arm 305 up a sufficient distance to shut off the activation switch 310, which stops water from entering the interior of the water leveler 100. The activation switch 310 is a pressure-activated switch, in the preferred embodiment. Pressure, provided by the activation arm 305, causes the switch 310 to close. Release of pressure, which occurs when the water level in the leveler 100 drops below a pre-set level, causes the switch 310 to open, allowing water to enter the leveler 100.

The water leveler 100 is connected to a water supply source via water supply tube 320 that supplies water at a constant pressure to the leveler 100. The water is provided at the same water pressure that is provided to residential houses, in the preferred embodiment. Water is provided to the pond via water outlet tube 335. Both, the water supply tube 320 and the water outlet tube 335 are made of PVC tubing in the preferred embodiment. Of course, the tubes can be made of other materials, including metals, in other embodiments. Both ends of water outlet tube 335 are intentionally left open. This allows a direct relationship to exist between the water level in the pond and the water level in the leveler 100. When the water level in the pond drops, the water level in the leveler 100 also drops. And, when the water level in the present leveler 100 drops a sufficient distance, the activation switch 310 opens thereby causing additional water to enter the leveler 100, which raises the water level in the leveler 100. While the water level in the leveler 100 rises, water is forced by hydrostatic pressure into the pond, and the water level in the pond also rises. One or both ends of the water outlet tube 335 can be covered by a screen or strainer 300 to prevent debris from entering the leveler 100 from the pond.

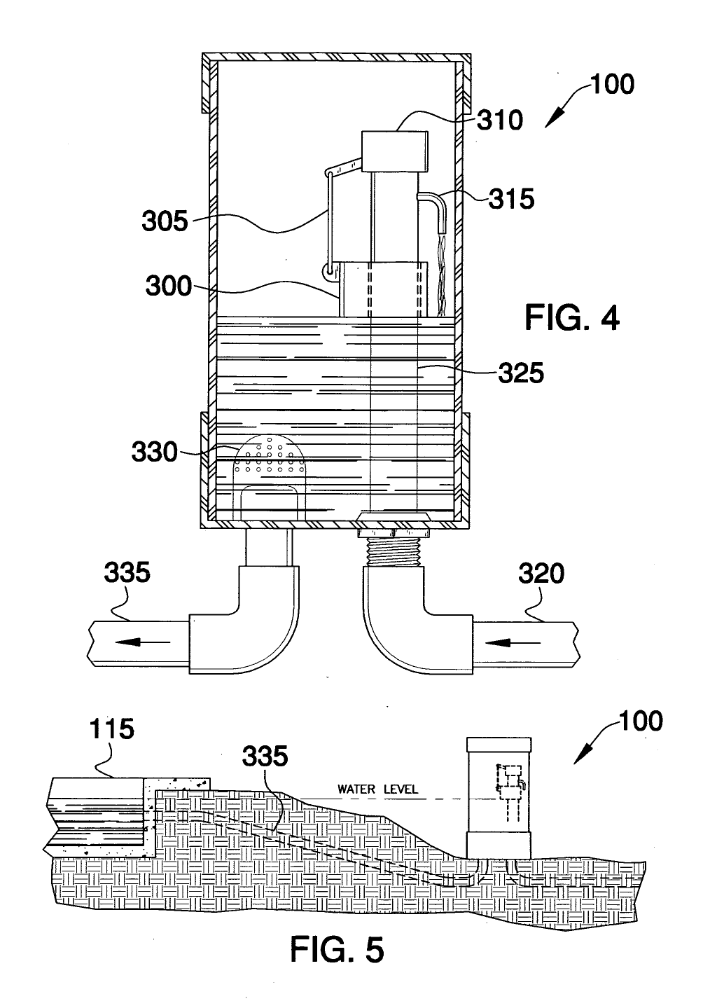

FIG. 4 shows the interior of the water leveler 100 when the water level has dropped below a pre-set threshold and the activation switch 310 has been moved into the “open” position, thereby allowing water to enter the leveler 100 via the fill tube 315. Because of the relationship between the height of the leveler 100 and the height of the desired water level in the pond, shown and discussed in conjunction with FIG. 5, when the water level in the pond drops, because of evaporation or leakage, the water level inside the leveler 100 also drops. When the water level in the leveler 100 drops a sufficient distance, the float 300 pulls the activation arm 305 down, which takes pressure off of the activation switch 310 causing the activation switch to open. When the activation switch opens, water is forced into the leveler 100, via water supply tube 320, water inlet tube 325 and finally fill tube 315.

FIG. 5 shows the direct relationship between the desired water level in the pond 115 and the full water level in the leveler 100. In the preferred embodiment, the leveler 100 is positioned so that the “full” water level in the leveler 100 is at a height that is the same height as the desired water level in the pond 115. The water outlet tube 335 provides an open water path between the pond 115 and the leveler 100. Thus as the water level of the pond 115 drops so to does the water level in the leveler 100. When the water level in the leveler 100 drops below a pre-defined distance (approximately 2-3 inches in the preferred embodiment) the activation switch in the leveler 100 is activated causing an influx of water into the water leveler 100. Because of hydrostatic (water) pressure and the positional relationship between the leveler 100 and the pond 115, as the water level in the leveler 100 rises so to does the water level in the pond 115. When the water level in the leveler 100 reaches the pre-defined full level, the activation switch is de-activated and the influx of water is stopped. Thus, stopping the flow of water into the interior of the leveler 100 and at the same time stopping the flow of water to the pond 115.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A device that is adapted for connection to a structure that holds water, including ponds, pools and fountains, wherein the device automatically maintains a desired level of water in the structure and wherein the device can be placed at a location that is remote from the structure, the device comprising:
a reserve tank that receives a water from a water supply and selectively dispenses the water to the structure;
a water supply tube, the water supply tube having a first end that extends into an interior of the reserve tank and a second end connected to the water supply;
a water outlet tube, the water outlet tube having a first end connected to a lower portion of the reserve tank and a second end connected to the structure;
a pressure sensitive switch, the switch being connected to the first end of the water supply tube, wherein the switch allows the water to enter the interior of the reserve tank when the switch is in an open position and the switch prevents the water from entering the reserve tank when the switch is in a closed position;
a floating part that floats on top of the water in the reserve tank, the floating part being mechanically connected to the pressure sensitive switch, wherein when the water in the reserve tank is at a pre-defined full level the floating part causes the switch to move to the closed position, and when the water in the reserved tank drops below a pre-defined low level the floating part causes the switch to move to the open position.

2. The device of claim 1, wherein the desired level of water in the structure is at a first height and the pre-defined full level in the reserve tank is also at the first height.

3. The device of claim 1, wherein the first and second ends of the water outlet tube are open and unobstructed so that a flow of water from the reserve tank to the structure is controlled by hydrostatic pressure.

4. The device of claim 1, wherein the location where the device is placed is a distance away from the structure sufficient enough to allow the device to be at least partially hidden behind an object, including natural objects and man-made objects.

5. The device of claim 1, wherein the reserve tank is cylindrical in shape and includes a removable cover.

6. The device of claim 1, wherein at least one of the ends of the water outlet tube is covered by a strainer that allows the water to pass through but blocks debris.

7. The device of claim 1, wherein the water supply tube is connected to a bottom of the reserve tank.

8. The device of claim 1, wherein the water outlet tube is connected to a bottom of the reserve tank.

9. The device of claim 1, wherein the water supply provides water to the reserve tank at a constant water pressure.

10. The device of claim 1, wherein the water supply tube and the water outlet tube are each made of PVC pipe.

11. The device of claim 1, wherein the water supply tube is connected to the reserve tank by a threaded coupler.

12. The device of claim 1, wherein a length of the water outlet tube is buried under ground and the second end of the water outlet tube is below the desired level of water in the structure.
